(19) United States
(12) Patent Application Publication
(10) Pub. No.: US 2014/0041361 A1
(43) Pub. Date: Feb. 13, 2014

(54) SYSTEM, APPARATUS AND METHOD FOR QUICK WARM-UP OF A MOTOR VEHICLE

(71) Applicant: Cooper-Standard Automotive, Inc., Novi, MI (US)

(72) Inventors: George Moser, Brighton, MI (US); Adam Ostapowicz, Orchard Lake Village, MI (US); Lawrence C. Kennedy, Baldwin, MI (US); Thomas Lauinger, Karlsruhe (DE)

(73) Assignee: Cooper-Standard Automotive, Inc., Novi, MI (US)

(21) Appl. No.: 13/962,032

(22) Filed: Aug. 8, 2013

Related U.S. Application Data
(63) Continuation-in-part of application No. 13/570,725, filed on Aug. 9, 2012.

(51) Int. Cl. F02N 19/10

(52) U.S. Cl. CPC F02N 19/10
USPC 60/273; 60/320

(57) ABSTRACT

A system for quick warm-up of a motor vehicle includes a housing, a heat collector, and a valve mechanism. The housing includes an input port and an output port, and defines a first exhaust flow path between the input port and the output port. The heat collector is in fluid communication with the housing and defines a second exhaust flow path. The heat collector includes an inlet and an outlet and further defines a fluid path between the inlet and the outlet. The valve mechanism is disposed within the housing and is operable to control the flow of exhaust between the first exhaust flow path and the second exhaust flow path.

### CROSS-REFERENCE TO RELATED APPLICATIONS

This application is a continuation-in-part of U.S. patent application Ser. No. 13/570,725 filed on Aug. 9, 2012. The entire disclosure of the above application is incorporated herein by reference.

### FIELD

The present teachings generally pertain to a system and apparatus for quick warm-up of a motor vehicle. The present teachings also pertain to a related method for quick warm-up of a motor vehicle.

### BACKGROUND

This section provides background information related to the present disclosure which is not necessarily prior art.

Motor vehicles are operated in a wide range of ambient temperatures. Thermal comfort within a passenger cabin is very important for today's motor vehicles. Modern vehicles include HVAC (heating, ventilating and cooling) systems to handle passenger comfort. Until the motor vehicle sufficiently warms during operation in lower ambient temperatures, the vehicle passengers may be cold and the windows may be frosted for several minutes. Furthermore, operation of a motor vehicle in cooler ambient conditions is less efficient. For example, the engine may produce a greater amount of noxious gases and the transmission may operate less than optimally.

FIG. 1 illustrates a prior art system for delivering heat to a passenger cabin. In a conventional motor vehicle, heat is extracted from the engine and directed to a heater core disposed within the passenger compartment. The heater core is in fluid communication with a radiator and the engine of the vehicle. A pump operates to circulate heated fluid (e.g., coolant) from the engine to both the heater core and the radiator. Heat is extracted from the fluid by both the radiator and the heater core. The pump further operates to circulate the cooled fluid from both the radiator and the heater core back to the engine for further cooling of the engine.

Upon start-up of the vehicle, a period of time is required to sufficiently heat the coolant and resultantly provide heat to the passenger cabin through the heater core. With cooler ambient conditions, the period of time increases. As a result, a passenger in the passenger cabin may be required to wait several minutes before appreciable heat may be delivered to the passenger compartment and before the windshield may be defrosted.

In addition to a vehicle engine, another source of heat in a motor vehicle is the exhaust system. A conventional exhaust system for a motor vehicle is schematically illustrated in FIG. 2. The exhaust system operates to process exhaust or exhaust gases from the vehicle engine and direct the exhaust away from the passenger cabin of the vehicle. The exhaust system is shown to generally include a catalytic converter and a muffler. The exhaust system may also optionally include a resonator. A manifold (not shown) typically collects exhaust from the cylinders of the engine and routes the exhaust gas to a single pipe. The exhaust is initially received by the catalytic converter.

The catalytic converter converts noxious emissions into less harmful emissions before the exhaust leaves the exhaust system. A typical catalytic converter employs a reduction catalyst and an oxidation catalyst. Both catalysts generally consist of a ceramic structure coated with a metal catalyst. The metal catalyst is generally platinum, rhodium and/or palladium. The reduction catalyst reduces NOx emissions. The oxidation catalyst reduces unburned hydrocarbons and carbon monoxide by burning (i.e., oxidizing) them over a platinum and/or palladium catalyst. A catalytic converter performs at extremely high temperatures. Temperatures of exhaust exiting the catalytic converter may reach or exceed 600 degrees Fahrenheit.

Where present, the exhaust exiting the catalytic converter may next enter the resonator. The resonator includes a resonator chamber for tuning a sound of the exhaust.

The exhaust exiting the resonator is directed along the exhaust path to one or more mufflers. The muffler functions to reduce the amount of noise emitted by the exhaust system. Finally, exhaust from the muffler passes through a tailpipe.

To a limited extent, it has been heretofore proposed to extract heat from a vehicle exhaust system and deliver the extracted heat to the passenger cabin. It has not been possible to successfully commercialize such prior proposals given the various associated disadvantages. These disadvantages include both cost and safety.

Accordingly, a continuous need for improvement remains in the pertinent art. In this regard, it is desirably to harness the heat of a vehicle exhaust system to safely and quickly warm a passenger compartment for passenger comfort and convenience and perhaps also warm the engine and transmission for improved vehicle operation.

### SUMMARY

In accordance with one particular aspect, the present teachings provide a system for quick warm-up of a motor vehicle. The system includes a housing, a heat collector, and a valve mechanism. The housing includes an input port and an output port, and defines a first exhaust flow path between the input port and the output port. The heat collector is in fluid communication with the housing and defines a second exhaust flow path. The heat collector includes an inlet and an outlet and further defines a fluid path between the inlet and the outlet. The valve mechanism is disposed within the housing and is operable to control the flow of exhaust between the first exhaust flow path and the second exhaust flow path.

In accordance with another particular aspect, the present teachings provide a method for quick warm-up of a motor vehicle. The method includes providing a housing defining a first exhaust flow path and providing a heat collector defining a second exhaust flow path. The method further includes circulating exhaust through the second exhaust flow path, circulating a coolant through the heat collector to extract heat from the exhaust, and actuating a valve mechanism to stop the circulation of the exhaust through the second exhaust flow path and start the circulation of exhaust through the first exhaust flow path.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic view of a prior art system for providing heat to a cabin of a motor vehicle.

FIG. 2 is a schematic view of a prior art exhaust system for a motor vehicle.

FIG. 3 is a schematic view of a system for quick warm-up of a motor vehicle construction in accordance with the present teachings.

FIG. 3A is a partially cut-away view of the heat collector of FIG. 3.

FIG. 4 is a schematic view of another system for quick warm-up of a motor vehicle construction in accordance with the present teachings.

FIG. 5 is a perspective view of a combination heater core constructed in accordance with the present teachings.

FIG. 6 is an exploded perspective view of another combination heater core constructed in accordance with the present teachings.

FIG. 7 is a top view of the combination heater core of FIG. 7.

FIG. 8 is a partially cut-away perspective view of an apparatus for quick warm-up of a motor vehicle.

FIG. 9 is a schematic view of another system for quick warm-up of a motor vehicle construction in accordance with the present teachings.

FIG. 10A is a cross-sectional view of an apparatus for providing quick warm-up of a motor vehicle, in accordance with the present teachings.

FIG. 10B is a cross-sectional view of the apparatus of FIG. 10A, shown in another configuration.

FIG. 11 is a first cross-sectional view of the apparatus of FIG. 10A taken along the line 11-11.

FIG. 12 is a second cross-sectional view of the apparatus of FIG. 10A taken along the line 12-12.

FIG. 13A is a cross-sectional view of an apparatus for providing quick warm-up of a motor vehicle, in accordance with the present teachings.

FIG. 13B is a cross-sectional view of the apparatus of FIG. 13A, shown in another configuration.

FIG. 14A is a cross-sectional view of an apparatus for providing quick warm-up of a motor vehicle, in accordance with the present teachings.

FIG. 14B is a cross-sectional view of the apparatus of FIG. 14A, shown in another configuration.

FIG. 15 is a cross-sectional view of an apparatus for providing quick warm-up of a motor vehicle, in accordance with the present teachings.

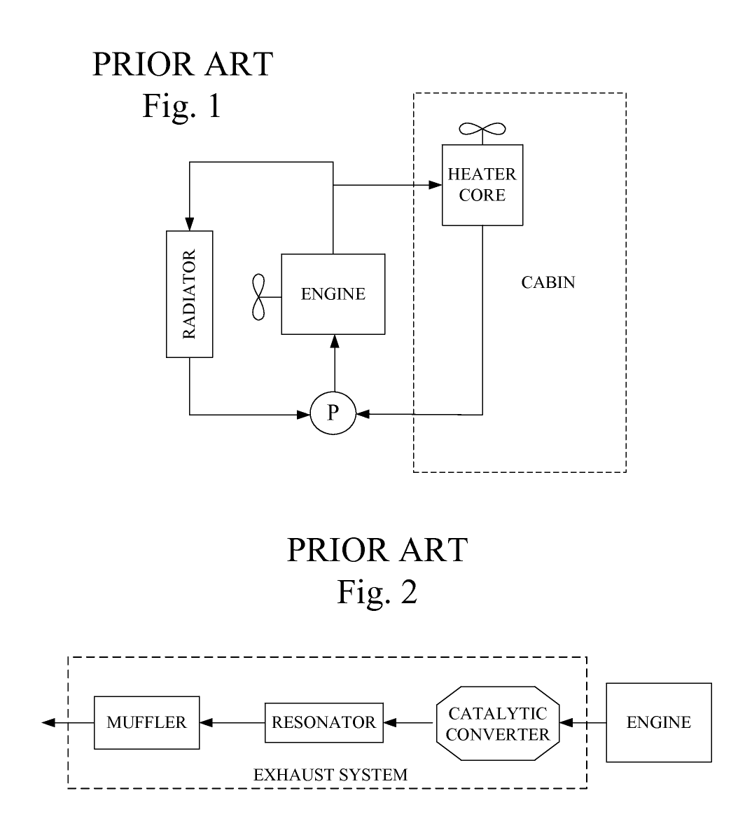

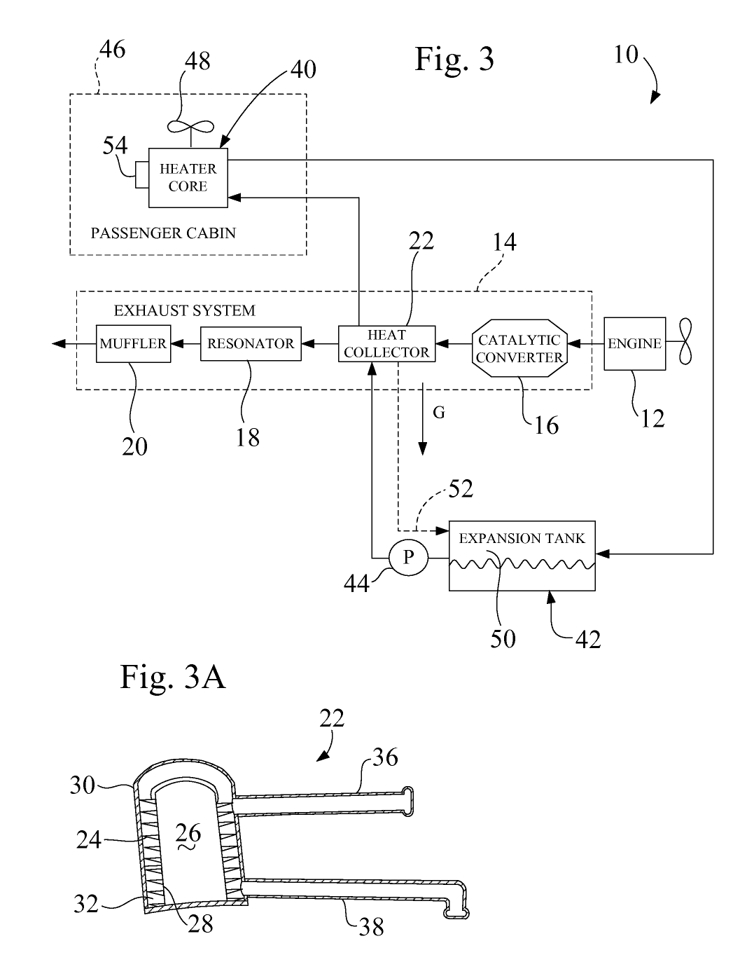

### DETAILED DESCRIPTION OF VARIOUS ASPECTS

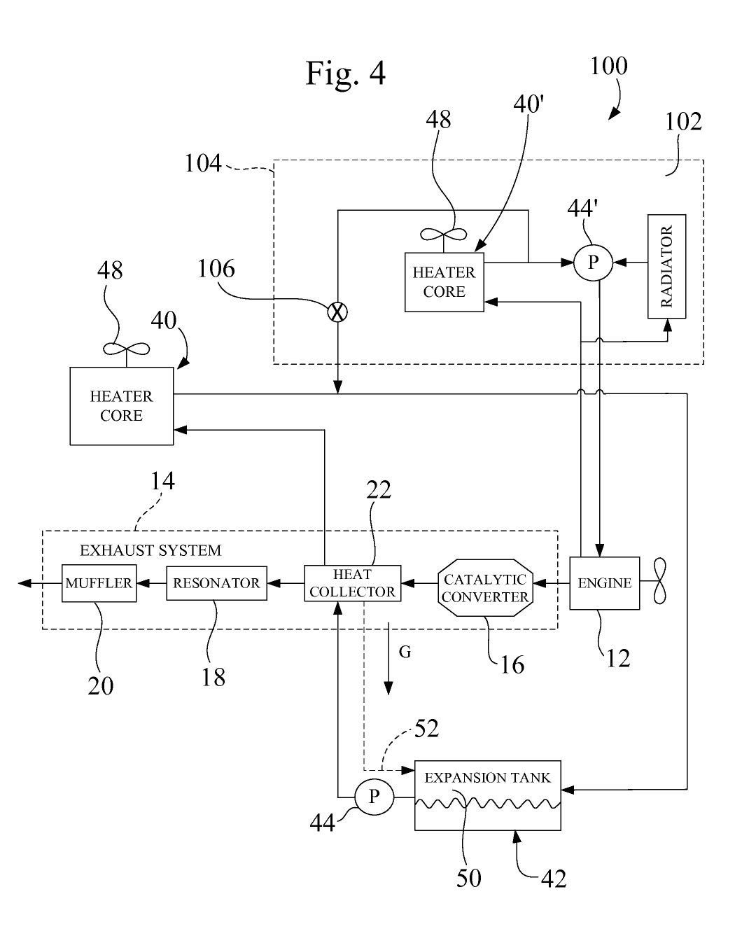

With reference to FIG. 3, a system for providing heat to a passenger cabin of a motor vehicle constructed in accordance with the present teachings is illustrated and generally identified at reference character 10. The system 10 is shown operatively associated with an engine 12 of a motor vehicle and an exhaust system 14 of the motor vehicle. The exhaust system 14 is generally shown to include a catalytic converter 16, a resonator 18 and a muffler 20. To the extent not otherwise described herein, it will be understood that the catalytic converter 16, the resonator 18 and the muffler 20 are conventional in both construction and operation.

The system 10 is illustrated to generally include a heat collector 22. The heat collector 22 is located downstream from the catalytic converter 16 and is operative to extract heat from the heated exhaust. While the heat collector 22 may be located at various points in the exhaust system 14, the heat collector 22 is preferably located immediately after the catalytic converter 16. In this location downstream from the catalytic converter 16, the heat collector 22 does not adversely impact the operation of the catalytic converter 16 but otherwise is able to extract heat from the exhaust at the hottest location of the exhaust.

The construction of the heat collector 22 will be described with reference to FIG. 3A. As generally illustrated, the heat collector 22 may include a jacket 24 for circumferentially surrounding a pipe extending from the catalytic converter 16. The jacket 24 may be generally tubular in shape and may define an inner cavity 26 sized to receive the pipe. The jacket 24 may include an inner wall 28 radially spaced from an outer wall 30. The inner wall 28 directly receives heat from the pipe extending from the catalytic converter. A chamber or fluid path 32 may be defined between the inner and outer walls 28 and 30.

A heat absorbing arrangement may be disposed in the fluid path 32 of the heat collector 22. The heat absorbing arrangement may include a plurality of fins 34. The fins 34 may be constructed of a suitable metal for receiving heat from the inner wall 28 and transferring a portion of the heat to the outer wall 30. As will be appreciated below, the fins 34 may operate to more efficiently transfer heat from the exhaust to a fluid passing through the fluid path 32.

The heat collector 22 is further illustrated to generally include an inlet 36 and an outlet 38. The inlet and outlet 36 and 38 are in fluid communication with the fluid path 32 of the heat collector 22. The inlet 36 is also in fluid communication with a heater core 40 for receiving a cooled fluid (i.e., coolant) from the heater core 40. In the embodiment illustrated, the fluid may be propylene glycol or similar fluid that prevents freezing at ambient temperatures below 32 degrees Fahrenheit an also has a relatively high boiling point.

The outlet 38 is also in fluid communication with an expansion tank 42 and a pump 44 for routing coolant warmed by the heat collector 22 back to the heater core 40. The pump may be a small, low cast 12 VDC pump that operates by a thermostatic switch with a normally off circuit. In the embodiment illustrated, the pump is a centrifugal pump or any other known type of pump that allows significant back flow when not in use.

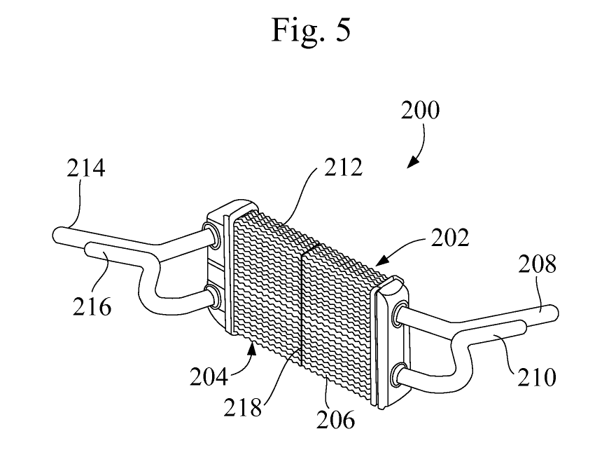

As illustrated, the pump is illustrated between the heat collector 22 and the expansion tank 42. In other embodiments, the pump 44 may be positioned between the expansion tank 42 and the heater core 40. It will be understood that the pump 44 may be located anywhere within the coolant flow path with the scope of the present teachings. In the same regard, the flow of coolant in the schematic illustration of FIG. 4 is clockwise (i.e., from the pump 44 to the heat collector 22, to the heater core 40, to the expansion tank 42 and back to the pump 44. In this way, heat is gather from the heat collector 22 and then transferred directly to the heater core 40 where it dissipates the heat for faster passenger cabin 46 or other component warm-up. It will be understood by those skilled in the art, however, that the flow of coolant may be in an opposite direction within the scope of the present teachings.

The heater core 40 may be located in proximity to a passenger cabin 46 of the motor vehicle. In this regard, the heater core 40 may be located directly in the passenger cabin 46. The heater core 40 is operatively associated with a fan 48. The fan 48 may be used to distribute heat from the heater core 40 throughout the passenger cabin 46 through an HVAC system for the comfort of the passengers. The fan 48 may also be used to directed heat from the heater core 40 to a windshield of the motor vehicle for defrosting the windshield.

Within the scope of the present teachings, it will be understood that the heater core 48 may be conventional in both construction and operation. In this regard, the heater core 48 may receive heated coolant and route the heated coolant through one or more winding tubes of a core. Fins attached to the core tube(s) may serve to increase surface area for heat transfer to air that is forced past the heater core 48 to thereby heat the passenger compartment.

The expansion tank 42 defines a chamber 50 for holding an amount of the coolant. The expansion tank 42 protects the system 10 from excess pressure. The tank 42 is partially filled with air. The compressibility of the air may conventionally absorb excess water pressure caused by thermal expansion. Furthermore, and as will be discussed below, the expansion tank 42 may retain coolant that drains from the heat collector 22 when it is not necessary to deliver further heat to the heater core 40.

In the embodiment illustrated, the expansion tank 42 is shown below the heat collector 22. In this manner, a gravitational force G acts in a direction from the heat collector 22 to the expansion tank 42. When coolant is not being routed through the system 10 to deliver heat to the heater core 40, coolant from the heat collector 22 may drain solely under gravitational force G from the heat collector 22 to the expansion tank 42. Condensation at the heat collector 22 will drip back down to the expansion tank 42.

In the embodiment illustrated, the coolant that drains from the heat collector 22 to the expansion tank 42 may drain along the normal flow path for the fluid during operation of the system. Alternatively or additionally, coolant may drain through a supplemental drain path 52. The drain path 52 may be a small diameter bypass tube inserted between the pump outlet and the expansion tank 42. The output pressure of the pump 44 may significantly exceed any resultant back pressure of the bypass tube such that a majority of the flow goes directly to the heat collector 22 and then to the heater core 40. When not in use, the back flow will return easily to the expansion tank 42 via this small diameter tube.

It will now be appreciated that the system 10 of the present teachings is operative to quickly deliver a source of heat from the exhaust system 14 to the passenger cabin 46 upon vehicle start-up. In operation, heated exhaust from the engine 12 is received by the catalytic converter 16. After the catalytic convert 16 acts on the exhaust, the exhaust passes through a pipe that is circumferentially surrounded by the heat collector 22. At this point, the temperature of the exhaust may be approximately 600 degrees Fahrenheit.

The system 10 of the present teachings may include one or more sensors 54. For example, a sensor 54 may sense a temperature of the heater core 40. Alternatively, sensors may sense a temperature of the passenger cabin 46, a temperature of the heater core 22 or a temperature at other points in the system 10.

Operation of the pump 44 may be controlled by the one or more sensors 54. In this regard, when the vehicle is started, the pump 44 is normally off. The pump 44 may begin to circulate coolant through the system 10 a predetermined minimum temperature is sensed by the sensor. For example, the pump 44 may begin to circulate coolant through the system when an ambient temperature is sensed by the sensor 54 that is below the predetermined minimum temperature. In one particular application, this predetermined minimum ambient temperature may be approximately 60 degrees Fahrenheit.

The pump 44 may be also controlled by the one or more sensors 54 to cease operation upon sensing of a temperature above a predetermined temperature. For example, pumping of coolant through the system 10 may be discontinued when a sensor senses a predetermined maximum temperature. For example, pumping of coolant through the system 10 may be discontinued when a sensor senses a cabin temperature of approximately 68-72 degrees Fahrenheit. Upon reaching the predetermined maximum temperature within the passenger cabin 46, it is no longer necessary to route supplemental heat to, the heater core 40. It will be understand that the predetermined minimum and maximum temperature may be altered for various applications within the scope of the present invention. It will also be understood that the predetermined minimum and maximum temperatures may be sensed at various other locations (e.g., at the heater core, etc.)When the pump 44 is pumping coolant through the system 10, coolant enters the inlet of the heat collector 22. The coolant circumferentially flows around the interior 26 and collects heat from the interior wall 28, the outer wall 30 and the fins 32. The heated coolant exits the heat collector 22 through the outlet 38 and is routed to the heater core 40. After the heater core 40, the cooled coolant is routed to the expansion tank 42 and then to the pump.

When pumping of coolant through the system 10 is stopped, it is important to drain or otherwise remove any coolant from the heat collector. In the embodiment illustrated, any fluid remaining in the heat collector 22 is allowed to drain from the heat collector back to the expansion tank 42 solely under gravitational force G. Additionally, any condensation in the heat collector 22 may drip back to the expansion tank 42. While not preferred, various valves may be employed within the system 10 within the scope of the present teachings.

Turning to FIG. 4, another system for providing heat to a cabin of a motor vehicle constructed in accordance with the present teachings is illustrated and generally identified at reference character 100. In view of the similarities between the system 10 and the system 100, common reference characters have been used to identify similar elements. The system 100 primarily differs from the system 10 in that the system 100 also extracts heat from the engine 12 of the vehicle for further heating of the passenger cabin 46.

In addition to the various elements shown and described with reference to FIG. 3, the system 100 additionally includes a second heater core 40′. As will be addressed below, in certain applications it may be desirable to utilize a combined heater core. The second heater core 40′ is in fluid communication with the vehicle engine 12. A second pump 44′ routes coolant warmed by the engine 12 to both a radiator 102 and the heater core 40′. The heater core 40′ may be identical in construction and operation to the heater core 40 described above. It will be understood that the radiator 102 may be of any structure well known in the art.

Heat is removed from the heated coolant by both the heater core 40′ and the radiator 102. The cooled coolant is routed back to the engine 12 for further cooling of the engine.

The heater core 40′, the radiator 102 and the pump 44′ effectively define a sub-system 104 of the system 100 for warming the passenger cabin 46. This sub-system 104 may be in fluid communication with the remainder of the system 10. In this manner, the coolant in the system 100 may be filled at a single point. A valve 106 may be located between the sub-system 104 and the remainder of the system 100.

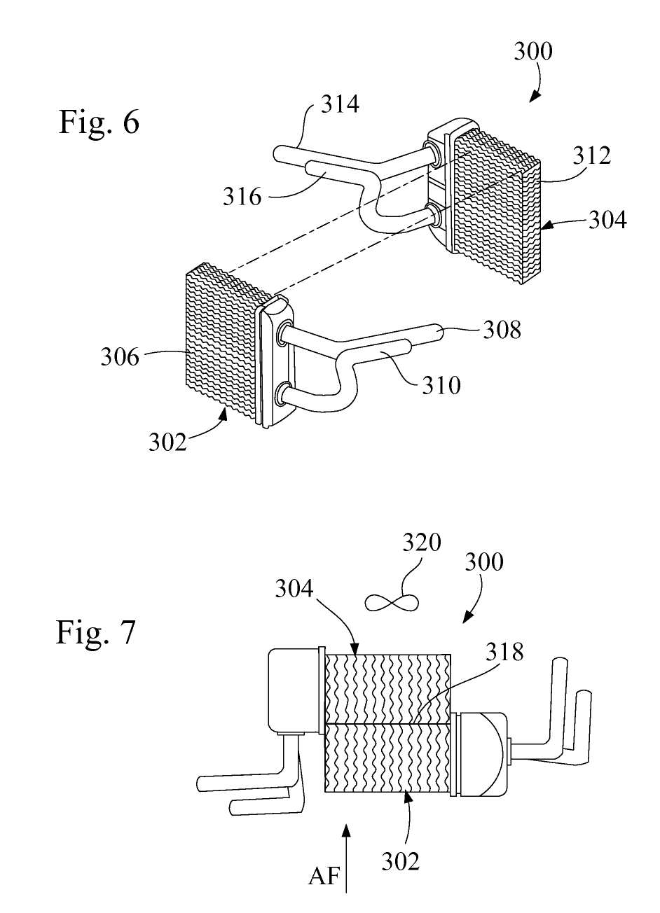

With reference to FIG. 5, a combination heater core constructed in accordance with the present teachings is illustrated and generally identified at reference character 200. In certain applications, it may be desirable to provide such a combination heater core 200 rather than two separate heater cores (e.g., as shown and described above with regarding to reference characters 40 and 40′).

As generally illustrated, the combination heater core 200 may include a first portion 202 and a second portion 204. The first portion 202 may include a first plurality of tubes 206 in fluid communication with a heat collector 22 through an inlet 208 and an outlet 210. Similarly, the second portion 204 may include a second plurality of tubes 212 in fluid communication with an engine 12 through and inlet 214 and an outlet 216. The first and second pluralities of tubes 206 and 212 may be horizontally spaced relative to one another and fluidly separated at a midline 218 of the combination heater core 200.

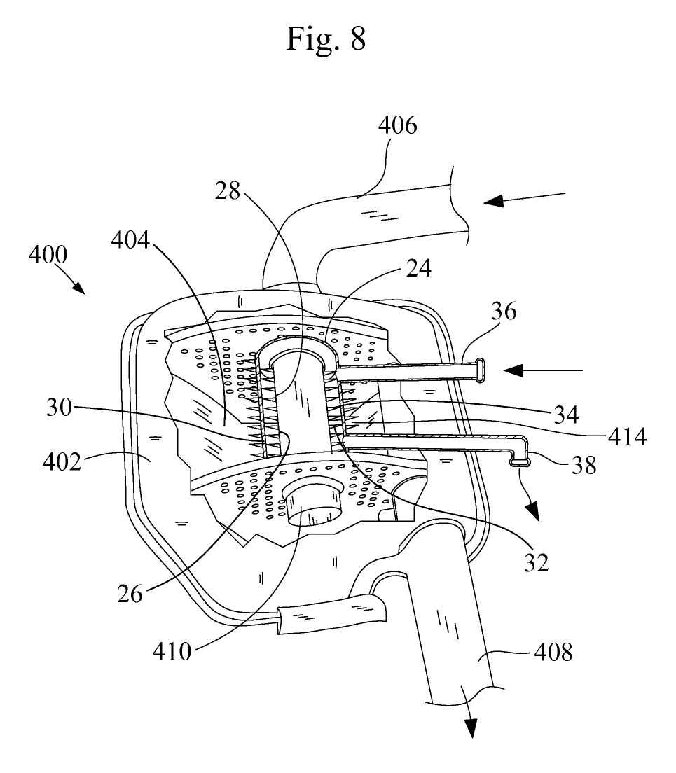

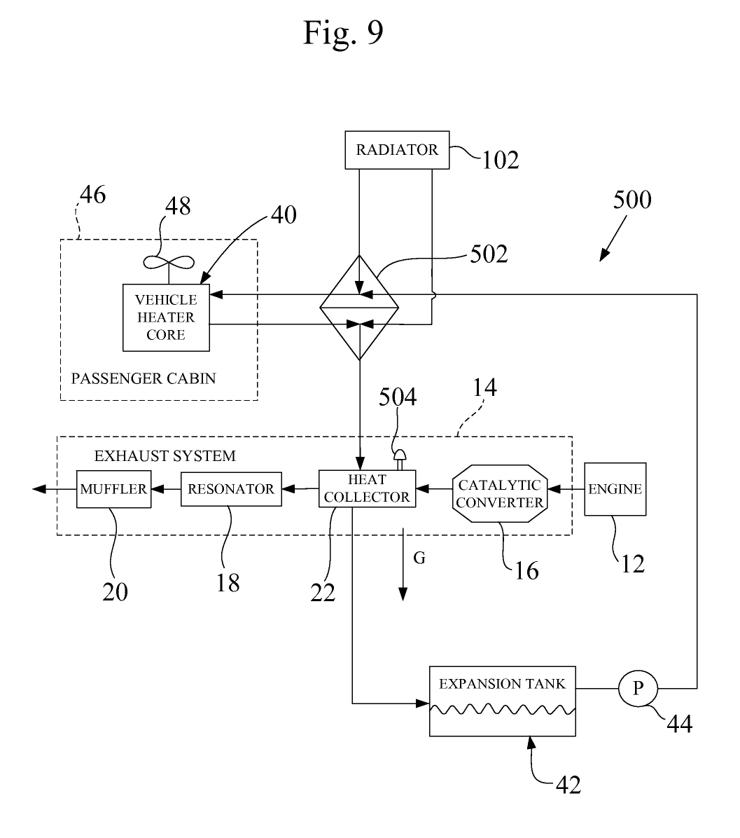

Turning to FIGS. 6 and 7, another combination heater core is illustrated and generally identified at reference character 300. Given the similarities between the combination heater core 200 and the combination heater core 300, common reference characters will be used to identify similar elements. The combination heater core 300 primarily differs from the combination heater core 200 in that a common airflow may pass through tubes of both portions of the heater core 300.

As generally illustrated, the combination heater core 300 may include a first portion 302 and a second portion 304. The first portion 302 may include a first plurality of tubes 306 in fluid communication with a heat collector 22 through an inlet 308 and an outlet 310. Similarly, the second portion 304 may include a second plurality of tubes 312 in fluid communication with an engine 12 through and inlet 314 and an outlet 316. The first and second pluralities of tubes 306 and 312 may be horizontally spaced relative to one another and fluidly separated at a midline 318 of the combination heater core 300. A common airflow drawn by a fan 320 may flow in a direction AF through both the first and second pluralities of tubes 306 and 312.

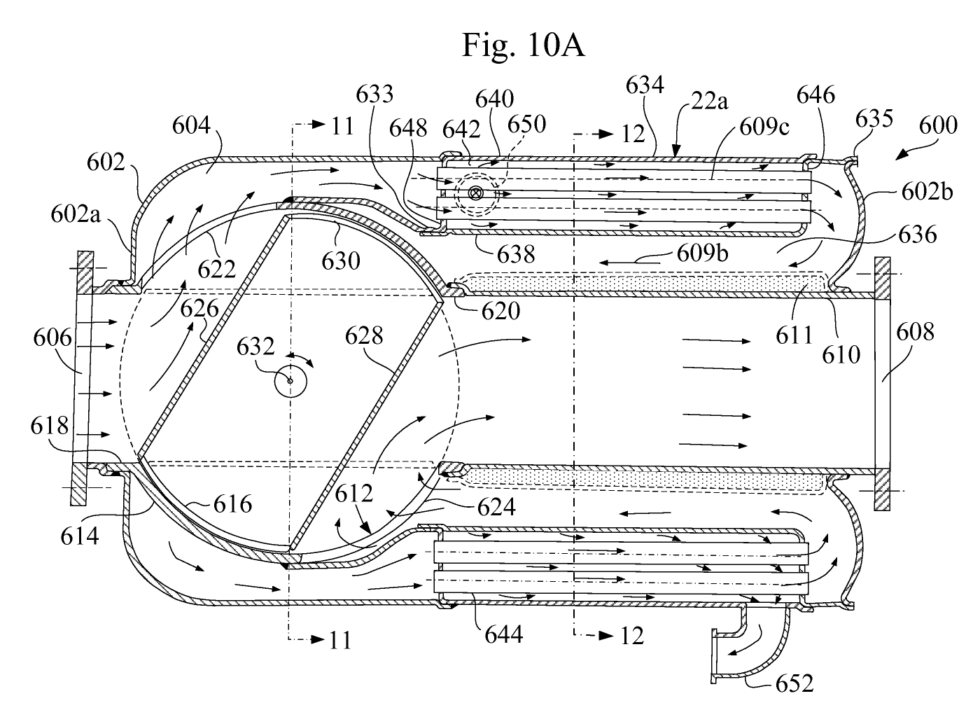

Turning to FIG. 8, an apparatus for quick warm-up of a motor vehicle constructed in accordance with the present teachings is illustrated and generally identified at reference character 400. As will be described, with the apparatus 400, the heat collector 22 of the present teachings may be incorporated into one of the conventional components of an exhaust system. As a result, the costs of the system may be reduced and packaging consideration alleviated. In this regard, the construction and operation of the heat collector 22 described above may be combined with the resonator 18 or the muffler 20, for example.

The apparatus 400 is generally shown to include a housing 402 defining a chamber 404. The apparatus 400 further includes an exhaust input port 406 and an exhaust output port 408. The input port 406 may receive heated exhaust from the catalytic converter 16. The outlet port 408 may deliver exhaust to a muffler 20 or a tailpipe (not shown).

An exhaust path extends from the exhaust input port 406 to the exhaust output port 408 and passes through the chamber 404. The exhaust path may be defined by a pipe 410. The chamber 404 may be a resonating chamber for tuning a sound of the exhaust.

A heat collector 22′ may be disposed in the chamber 404. The heat collector 22 may be operative to extract heat from the exhaust and may be in fluid communication with a heater core 40. In view of the similarities between the heat collector 22′ and the previously described heat collector 22, like reference characters will be used to identify similar elements.

The heat collector 22′ may include a jacket 24 for circumferentially surrounding the pipe 410 in fluid communication with the catalytic converter 16. The jacket 24 may be generally tubular in shape and may define an inner cavity 26 sized to receive the pipe. The jacket 24 may include an inner wall 28 radially spaced from an outer wall 30. The inner wall 28 directly receives heat from the pipe 410 extending from the catalytic converter. A chamber or fluid path 32 may be defined between the inner and outer walls 28 and 30.

A heat absorbing arrangement may be disposed in the fluid path 32 of the heat collector 22′. The heat absorbing arrangement may include a first plurality of fins 34. The fins 34 may be constructed of a suitable metal for receiving heat from the inner wall 28 and transferring a portion of the heat to the outer wall 30. The heat absorbing arrangement may further include a second plurality of fins 414 radially extending outward from the outer wall 30.

The heat collector 22′ is further illustrated to generally include an inlet 36 and an outlet 38. The inlet and outlet 36 and 38 are in fluid communication with the fluid path 32 of the heat collector 22. The inlet 36 is also in fluid communication with a heater core 40 for receiving a cooled fluid (i.e., coolant) from the heater core 40. The outlet 38 is also in fluid communication with an expansion tank 42 and a pump 44 for routing coolant warmed by the heat collector 22 back to the heater core 40.

A heat collector 22 or 22′ may similarly be incorporated into a combined housing with a muffler, catalytic converter, exhaust pipe, exhaust manifold, or any other component or pipe along a vehicle's exhaust path. Additionally, it will be understood that the present teachings, including the heat colletor 22 or 22′, may be employed for applications not including a catalytic converter.

The above systems 10 and 100 are described in connection with the delivery of heat to the passenger cabin of a motor vehicle. Alternatively, the heat extracted from the exhaust system may be used to heat the engine upon start-up to reduce noxious gases or to heat the transmission to reduce drag while the transmission fluid is not sufficiently viscous. Where the system 10 or 100 employs a combination heater core, it may be desirable to heat the engine without delivering heat to the passenger cabin. For example, on a sunny, cool day, the passenger cabin may approach 100 degrees Fahrenheit or more, while the engine may be 50 degrees Fahrenheit at start-up.

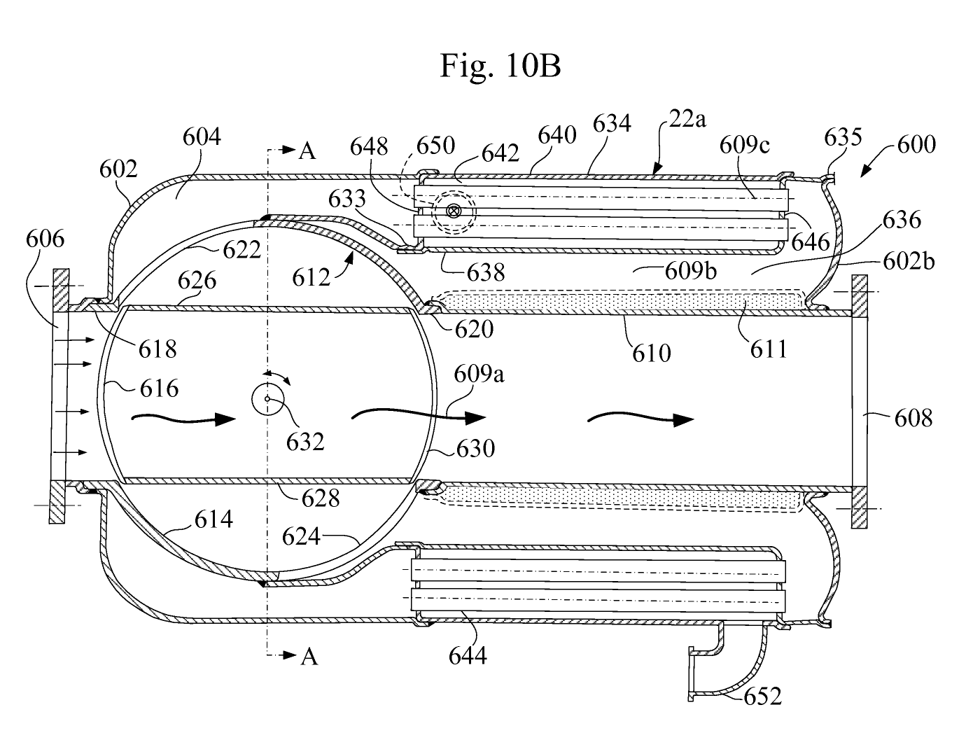

Turning to FIG. 9, another system for providing heat to a cabin of a motor vehicle constructed in accordance with the present teachings is illustrated and generally identified at reference character 500. In view of the similarities between the previously described systems 10 and 100, common reference characters have been used to identify similar elements with system 500. The system 500 primarily differs from the previously described systems 10 and 100 in that a single heater core 40 is disposed in the passenger cabin 46 for selectively receiving heat from the engine 12 and/or the exhaust system 14.

In the embodiment illustrated, the system 500 shares a common coolant. This sharing of coolant may extend coolant life through a closed system. Additionally, this sharing of coolant may allow for rejuvenation of the coolant routed through the exhaust system 14 with the main engine coolant.

The system 500 incorporates one or more valves for diverter valve 502 for selectively controlling the flow of coolant from the radiator 102 to the heater core 40, from the heat collector 22 to the heater core 40, from the heater core 40 to the radiator, and from the heater core 40 to the expansion tank 42. In the embodiment illustrated, the various flows of coolant is controlled by a common diverter valve 502. As illustrated, the diverter valve 502 is a four-way diverter valve 502. A pressure relief valve 504 may be incorporated into the heat collector 22.

In operation, the valve 504 may allow for coolant to flow from the heater core 40 to the heat collector 22 and the valve 504 may close the flow of coolant in undesired directions. With this embodiment, an additional heater core 40 is not necessary. Furthermore, weight may be saved by utilizing the vehicle's existing engine coolant.

The valve 504 may operate to totally prevent back flow in the case of a valve failure. Back flow may be prevented by inclusion of a redundant internal check valve. In this manner, a fail safe condition is provided.

The valve 504 may be controlled by a vehicle controller (not particularly shown). The controller may use a control algorithm established with look-up tables based on initial start of the engine (e.g., a time since last started), ambient temperature, cabin temperature, coolant temperature, and other inputs. It will be understood that the specific control algorithm is beyond the scope of the present teachings and that any suitable algorithm may be utilized.

As with the above systems 10 and 100, it will be understood that coolant may flow in the opposite direction to that shown in FIG. 9. Similarly, the pump 44 may be disposed at various locations within the system 500. Accordingly, it will now be appreciated by those skilled in the art that the present teachings provide systems for quick warm-up of a motor vehicle which are completely open. In this regard, the systems require no check valves but rather rely on gravitational force to drain fluid from a heat collector. As a result, a potential failure opportunity is completely eliminated.

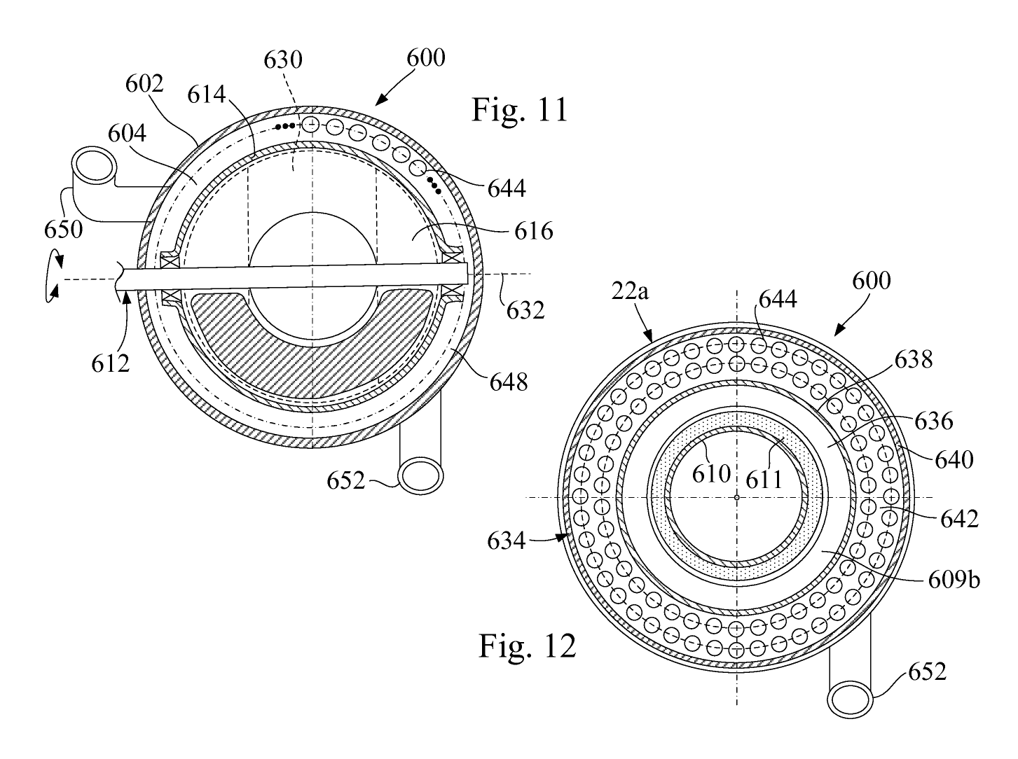

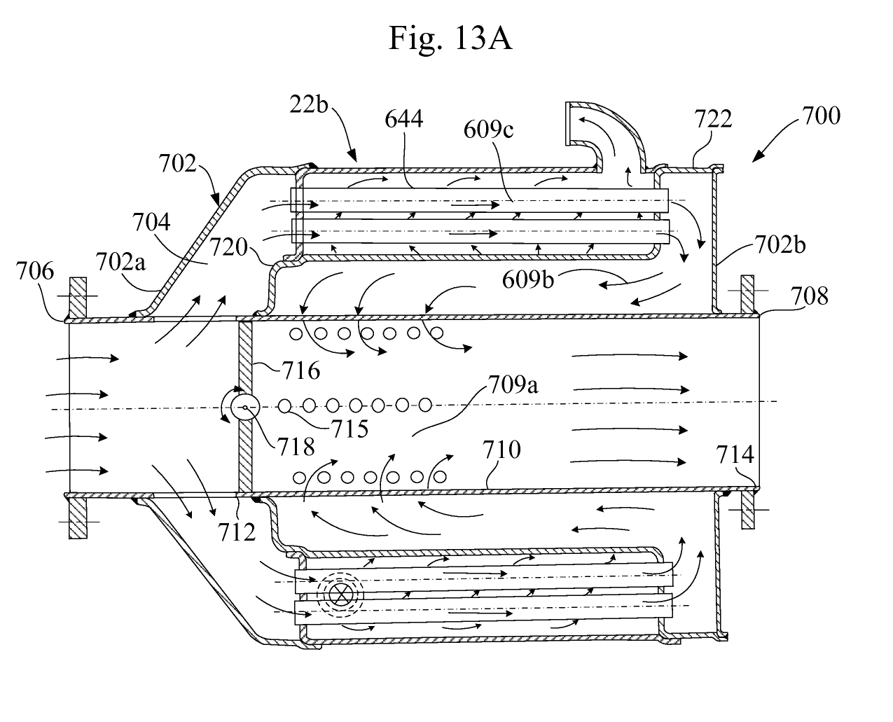

Turning to FIGS. 10A-12, another apparatus for quick warm-up of a motor vehicle constructed in accordance with the present teachings is illustrated and generally identified at reference character 600. Except as otherwise provided herein, the apparatus 600 may be similar to the apparatus 400, and similarly incorporated into systems 10, 100 for delivery of heat to the passenger cabin of a motor vehicle or delivery of heat to the engine upon start-up, as discussed above.

The apparatus 600 is generally shown to include a housing 602 having a first end 602a and a second end 602b, and defining a chamber 604 therebetween. The apparatus 600 further includes an exhaust input port 606 and an exhaust output port 608. The input port 606 may receive heated exhaust from the catalytic converter 16. The output port 608 may deliver exhaust to a muffler or a tailpipe (not shown). The chamber 604 may be a resonating chamber for tuning a sound of the exhaust.

With reference to FIG. 10b, a first exhaust path 609a extends from the exhaust input port 606 to the exhaust output port 608 and passes through the chamber 604. The exhaust path may be defined by a pipe 610. The pipe 610 may be substantially surrounded by a thermal insulator 611.

A valve mechanism or assembly 612 may be located between the pipe 610 and the exhaust input port 606 to control the flow of exhaust therebetween. The valve assembly 612 may include a valve housing 614 and a valve member 616. The valve housing 614 may be a generally spherical shell and include a first opening 618, a second opening 620, a third opening 622 and a fourth opening 624. The first opening 618 may be mounted to, or in communication with, the exhaust input port 606. The second opening 620 may be mounted to, or in communication with, the pipe 610. The third opening 622 and the fourth opening 624 may be operatively mounted to, or in communication with, a heat collector 22a.

The valve member 616 may be generally spherically shaped and include a first surface 626, a second surface 628, and an aperture 630. The first surface 626 may be opposite the second surface 628. The aperture 630 may extend in a first direction that is generally between the first and second surfaces 626, 628. The valve member 616 may be rotatably mounted within the valve housing 614, for rotation about an axis 632 that is generally perpendicular to the first direction.

The heat collector 22a may be disposed in the chamber 604. A first end 633 of the heat collector 22a may be mounted to the valve housing 614 and to the first end 602a of the housing 602. A second end 635 of the heat collector 22a may be mounted to the second end 602b of the housing 602. The heat collector 22a may be operative to extract heat from the exhaust and may be in fluid communication with a heater core 40.

The heat collector 22a may include a jacket 634 for circumferentially surrounding the pipe 610 in fluid communication with the catalytic converter 16. The jacket 634 may be generally tubular in shape and may define an inner cavity 636 sized to receive the pipe 610. The jacket 634 may include an inner wall 638 radially spaced from an outer wall 640. A chamber or fluid path 642 may be defined between the inner and outer walls 638 and 640. A second exhaust path 609b may be defined between the inner wall 638 and the pipe 610 or thermal insulator 611.

A heat absorbing arrangement may be disposed in the fluid path 642 of the heat collector 22a. The heat absorbing arrangement may include a plurality of tubes 644. The tubes 644 may be constructed of a suitable metal for transferring heat to the fluid path 642. The plurality of tubes 644 may extend between the inner and outer walls 638, 640, thereby defining a third exhaust path 609c. The third exhaust path 609c may be isolated from the fluid path 642 by first and second ends 646, 648 of the inner and outer walls 638, 640, respectively.

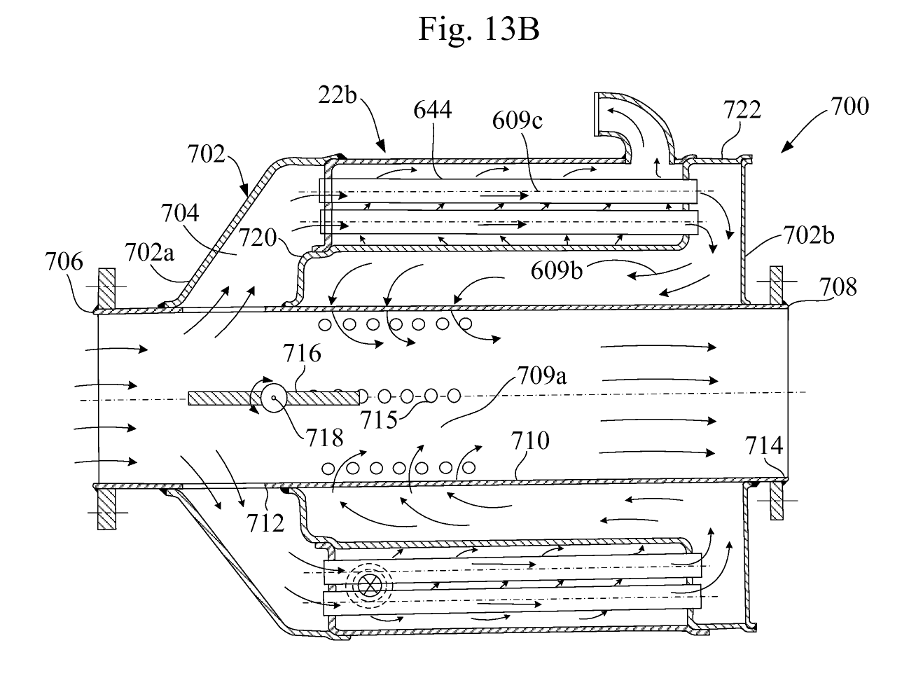

The tubes 644 may generally extend between the first and second ends 646, 648 of the inner and outer walls 638, 640 and may include a first array of tubes and a second array of tubes. The first array of tubes may be a circle formed of between thirty and fifty tubes 644. The second array of tubes may be a circle formed of between forty and sixty tubes 644. With reference to FIG. 12, in one particular configuration, the first array of tubes includes thirty-eight tubes 644 and the second array of tubes includes forty-four tubes 644. The tubes 644 may have a diameter between 5 and 10 millimeters. In one particular configuration, the tubes 644 have a diameter of 8 millimeters, such that a total exterior surface area of the first and second arrays of tubes 644, between the first and second ends 76, 78 of the coolant subassembly 26 is between 2000 square millimeters and 4000 square millimeters. It is also understood that, while the tubes 644 are described as having a diameter and are shown extending in a generally linear direction between the first and second ends 646, 648 of the inner and outer walls 638, 640, to help prevent laminar fluid flow within and around the tubes 644, the tubes may also have an irregular or asymmetric shape that extends between the first and second ends 646, 648, defining a non-uniform cross section. For example, the tubes 644 may extend in a zig-zagged, waved, or corrugated pattern or direction.

The heat collector 22a is further illustrated to generally include an inlet 650 and an outlet 652. The inlet and outlet 650 and 652 are in fluid communication with the fluid path 642 of the heat collector 22a. The inlet 650 may also be in fluid communication with the heater core 40 for receiving a cooled fluid (i.e., coolant) from the heater core 40. The outlet 652 may also be in fluid communication with the expansion tank 42 and the pump 44 for routing coolant warmed by the heat collector 22a back to the heater core 40 or to the engine or transmission (not shown).

The heat collector 22a may similarly be incorporated into a combined housing with a muffler, catalytic converter, exhaust pipe, exhaust manifold, or any other component or pipe along a vehicle's exhaust path. Additionally, it will be understood that the present teachings, including the heat collector 22a′, may be employed for applications not including a catalytic converter.

The heat collector 22a and apparatus 600 may be incorporated into the above systems 10 and 100, described in connection with the delivery of heat to the passenger cabin of a motor vehicle. Alternatively, the heat extracted from the exhaust system through heat collector 22a may be used to heat the engine upon start-up to reduce noxious gases or to heat the transmission to reduce drag while the transmission fluid is not sufficiently viscous. Where the system 10 or 100 employs a combination heater core, it may be desirable to heat the engine without delivering heat to the passenger cabin. For example, on a sunny, cool day, the passenger cabin may approach 100 degrees Fahrenheit or more, while the engine may be 50 degrees Fahrenheit at start-up.

Operation of the apparatus 600 and the heat collector 22a will now be described in more detail. With reference to FIG. 10A, in a first mode of operation, the valve member 616 may rotate about the axis 632 such that the exhaust flows from the exhaust input port 606 where it is directed through the third opening 622 in the valve housing 614 by the first surface 626 of the valve member 616. In the first mode of operation, valve housing 614 may prevent the exhaust from flowing through the aperture 630 in the valve member and through the first exhaust path 609a. Upon flowing through the third opening 622, the exhaust may flow in a first direction through the third exhaust path 609c defined by the plurality of tubes 644. Upon exiting the tubes 644, the exhaust may then flow in a second direction (opposite to the first direction) through the second exhaust path 609b prior to being directed through the fourth opening 624 in the valve housing 614 by the second surface 628 of the valve member 616. Thereafter, the exhaust may flow in the first direction through the pipe 610 prior to exiting through the exhaust output port 608. In the first mode of operation, heat from the exhaust may be transferred from the tubes 644 to the fluid flowing through the fluid path 642.

With reference to FIG. 10B, in a second mode of operation, the valve member 616 may rotate about the axis 632 such that the exhaust flows from the exhaust input port 606 and through the aperture 630 in the valve member 616. In the second mode of operation, the first and second surfaces 626, 628 of the valve member may prevent the exhaust from flowing through the third and fourth openings 622, 624 of the valve housing 614, and thus prevent the gas from flowing through the second and third exhaust paths 609b, 609c. Upon flowing through the aperture 630, the exhaust may exit the second opening 620 of the valve housing 614 and enter the pipe 610 prior to exiting through the exhaust output port 608. In the second mode of operation, heat from the exhaust is isolated and insulated (via thermal insulator 611) from the tubes 644 and the fluid path 642, thus preventing the transfer of heat from the exhaust to the fluid.

The apparatus 600 may also include a sensor (not shown) to measure a temperature of the fluid in the fluid path 642. When the temperature increases to a certain pre-defined level, the valve member 616 may rotate from the first position (FIG. 10A) to the second position (FIG. 10B), preventing any further transfer of heat from the exhaust to the fluid, and thus preventing any further increase in the temperature of the fluid. In one configuration, the pre-defined temperature may be approximately 212 degrees Fahrenheit.

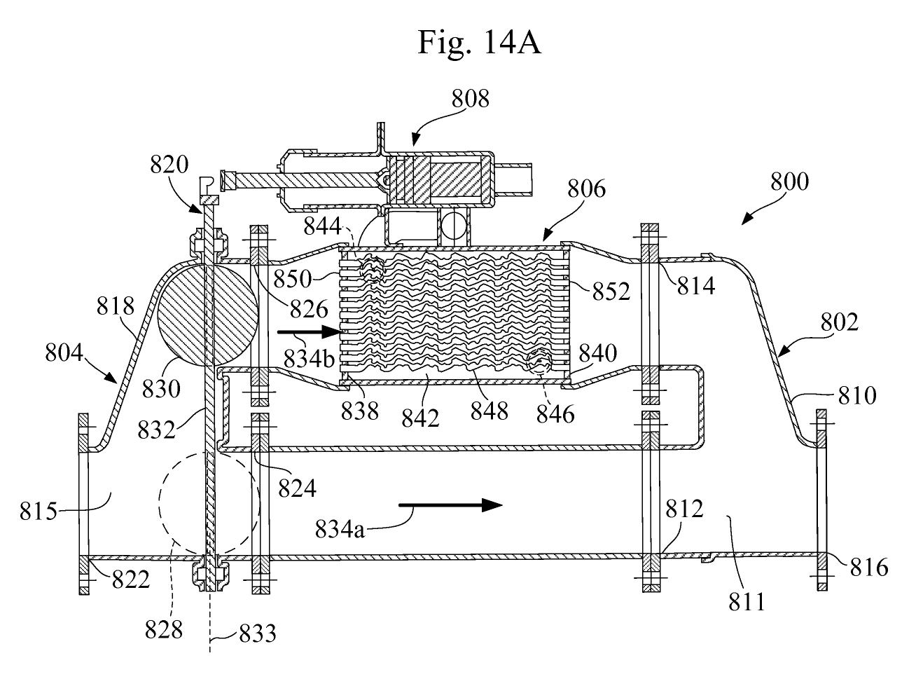

Turning to FIGS. 13A-13B, another apparatus for quick warm-up of a motor vehicle constructed in accordance with the present teachings is illustrated and generally identified at reference character 700. Except as otherwise provided herein, the apparatus 700 may be similar to the apparatus 600, and similarly incorporated into systems 10, 100 for delivery of heat to the passenger cabin of a motor vehicle or delivery of heat to the engine upon start-up, as discussed above.

The apparatus 700 is generally shown to include a housing 702 having a first end 702a and a second end 702b, and defining a chamber 704 therebetween. The apparatus 700 further includes an exhaust input port 706 mounted to the first end 702a of the housing and an exhaust output port 708 mounted to the second end 702b of the housing. The input port 706 may receive heated exhaust from the catalytic converter 16. The output port 708 may deliver exhaust to a muffler 20 or a tailpipe (not shown). The chamber 704 may be a resonating chamber for tuning a sound of the exhaust.

A first exhaust path 709a extends from the exhaust input port 706 to the exhaust output port 708 and passes through the chamber 704. The first exhaust path 709a may be defined by a pipe 710 having a first end 712, a second end 714, and a plurality of apertures 715 therebetween. The second end 714 of the pipe 710 may be located adjacent to the output port 708. The apertures 715 may be arranged in various configurations. With reference to FIGS. 13A-13B, in one configuration the apertures 715 are arranged in a series of linear rows, each extending from the first end 712 of the pipe to a location approximately midway between the first end 712 and the second end 714. The rows may be arranged circumferentially around the pipe 710.

A valve mechanism 716 may located between the pipe 710 and the exhaust input port 706 to control the flow of exhaust between the pipe and the exhaust input port. The valve mechanism 716 may be a generally circular or disc-shaped butterfly valve rotatably mounted within the housing 702 or the pipe 710, for rotation about an axis 718.

A heat collector 22b may be disposed in the chamber 704. Except as otherwise described herein, the heat collector 22b may be substantially identical to the heat collector 22a. Accordingly, like reference numerals will be used to describe similar features. A first end 720 of the heat collector 22b may be mounted to the pipe 710 and to the first end 702a of the housing 702. A second end 722 of the heat collector 22b may be mounted to the second end 702b of the housing 702

Operation of the apparatus 700 and the heat collector 22b will now be described in more detail. With reference to FIG. 13A, in a first mode of operation, the valve mechanism 716 may rotate about the axis 718 such that the exhaust flows from the exhaust input port 706 and through the chamber 704. In the first mode of operation, valve mechanism 716 may prevent the exhaust from flowing through the first end 712 of the pipe 710. Upon flowing through the chamber 704, the exhaust may flow in a first direction through the third exhaust path 609c defined by the plurality of tubes 644. The exhaust may then flow in a second direction (opposite to the first direction) through the second exhaust path 609b, and through the apertures 715 in the pipe 710. Thereafter, the exhaust may flow in the first direction through the pipe 710 prior to exiting through the exhaust output port 708. In the first mode of operation, heat from the exhaust may be transferred from the tubes 644 to the fluid flowing through the fluid path 642. With reference to FIG. 13B, in a second mode of operation, the valve mechanism 716 may rotate about the axis 718 such that the exhaust flows from the exhaust input port 706 and through the first end 712 of the pipe 710. The exhaust may flow through the pipe 710 and exit the apparatus 700 through the exhaust output port 708. In the second mode of operation, heat from the exhaust in the pipe 710 is isolated from the tubes 644 and the fluid path 642.

The apparatus 700 may also include a sensor (not shown) to measure a temperature of the fluid in the fluid path 642. When the temperature increases to a certain pre-defined level, the valve mechanism 716 may rotate from the first position (FIG. 13A) to the second position (FIG. 13B), preventing any further transfer of heat from the exhaust to the fluid, and thus preventing any further increase in the temperature of the fluid. In one configuration, the pre-defined temperature may be approximately 212 degrees Fahrenheit.

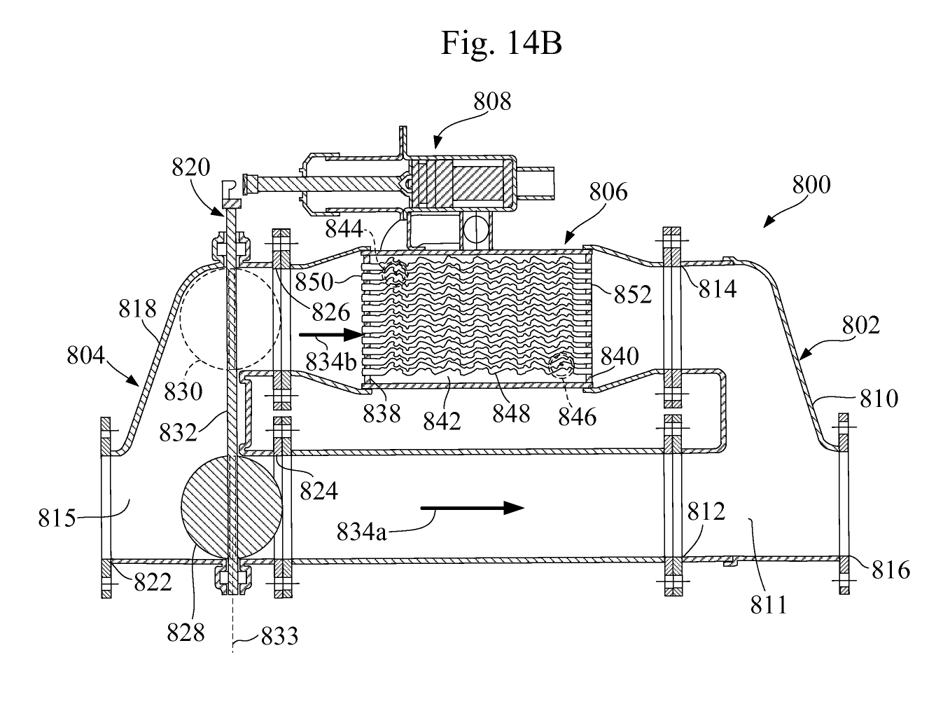

Turning to FIGS. 14A-14B, another apparatus for quick warm-up of a motor vehicle constructed in accordance with the present teachings is illustrated and generally identified at reference character 800. Except as otherwise provided herein, the apparatus 800 may be similar to the apparatus 600, and similarly incorporated into systems 10, 100 for delivery of heat to the passenger cabin of a motor vehicle or delivery of heat to the engine upon start-up, as discussed above.

The apparatus 800 is generally shown to include an output assembly 802, an input assembly 804, a heat collector 806, and an actuator assembly 808. The output assembly 802 may include a housing 810 defining a chamber 811 and including a first exhaust input port 812, a second exhaust input port 814, and an output port 816. The chamber 811 may be a resonating chamber for tuning a sound of the exhaust.

The input assembly 804 may include a housing 818 and a valve mechanism or assembly 820. The housing 818 may define a chamber 815 and may include an exhaust input port 822, a first exhaust output port 824 and a second exhaust output port 826. The input port 822 may receive heated exhaust from the catalytic converter 16. The first output port 824 may deliver exhaust to the first exhaust input port 812 of the output assembly 802. The second exhaust output port 826 may deliver exhaust to the heat collector 806. The chamber 815 may be a resonating chamber for tuning a sound of the exhaust.

The valve assembly 820 may include a first valve member 828, a second valve member 830, and an actuation arm 832. The first and second valve members 828, 830 may be circular, disc-like members fixed to the actuation arm 832 in an offset configuration such that the first valve member 828 is substantially perpendicular to the second valve member 830. The first valve member 828 may be located in the first exhaust output port 824, and the second valve member 830 may be located in the second exhaust output port 826. The actuation arm 832 may be rotatably mounted to the housing 818 for rotation about an axis 833, such that in a first position (FIG. 14A), the first valve member 828 allows exhaust to flow from the first output port 824 to the first input port 812 of the output assembly 802 (defining a first flow path 834a), while the second valve member 830 may prevent the flow of exhaust from the second output port 826 to the heat collector 806. In a second position (FIG. 14B), the first valve member 828 may prevent the flow of exhaust from the first output port 824 to the first input port 812 of the output assembly 802, while the second valve member 830 may allow exhaust to flow from the second output port 826 to the heat collector 806 (defining a second flow path 834b). The first flow path 834a may be laterally offset from the second flow path 834b. In one configuration, the first flow path 834a may be offset from the second flow path 834b by a distance between 40 millimeters and 60 millimeters.

The heat collector 806 may be operative to extract heat from the exhaust and may be in fluid communication with a heater core 40. The heat collector 806 may be substantially cylindrical, having a first end 838 and a second end 840, and defining a chamber or fluid path 842 therebetween. The heat collector 806 is illustrated to generally include an inlet 844 and an outlet 846. The inlet and outlet 844 and 846 are in fluid communication with the fluid path 842. The inlet 844 may also be in fluid communication with the heater core 40 for receiving a cooled fluid (i.e., coolant) from the heater core 40. The outlet 846 may also be in fluid communication with the expansion tank 42 and the pump 44 for routing coolant warmed by the heat collector 806 back to the heater core 40 or to the engine or transmission (not shown). A plurality of tubes 848 may extend through the fluid path 842, from the first end 838 to the second end 840. The tubes 848 may be constructed of a suitable metal for transferring heat to a fluid in the fluid path 842. A first end 850 of the tubes 848 is in fluid communication with the second output port 826, while a second end 852 of the tubes 848 is in fluid communication with the second input port 814, such that the second flow path 834b includes the tubes 848.

The heat collector 806 may similarly be incorporated into a combined housing with a muffler, catalytic converter, exhaust pipe, exhaust manifold, or any other component or pipe along a vehicle's exhaust path. Additionally, it will be understood that the present teachings, including the heat collector 806, may be employed for applications not including a catalytic converter.

The heat collector 806 and the apparatus 800 may be incorporated into the above systems 10 and 100, described in connection with the delivery of heat to the passenger cabin of a motor vehicle. Alternatively, the heat extracted from the exhaust system through heat collector 806 may be used to heat the engine upon start-up to reduce noxious gases or to heat the transmission to reduce drag while the transmission fluid is not sufficiently viscous. Where the system 10 or 100 employs a combination heater core, it may be desirable to heat the engine without delivering heat to the passenger cabin. For example, on a sunny, cool day, the passenger cabin may approach 100 degrees Fahrenheit or more, while the engine may be 50 degrees Fahrenheit at start-up.

Operation of the apparatus 800 and the heat collector 806 will now be described in more detail. With reference to FIG. 14A, in a first mode of operation, the actuation arm 832 may rotate the first valve member 828 and the second valve member 830 about the axis 833 such that the first valve member 828 prevents the flow of exhaust from the first exhaust output port 824 to the output assembly 802, while the second valve member 830 allows the exhaust to flow from the second exhaust output port 826 to the output assembly 802. In the first mode of operation, heat from the exhaust may be transferred from the tubes 848 to the fluid flowing through the fluid path 842.

With reference to FIG. 14B, in a second mode of operation, the actuation arm 832 may rotate the first valve member 828 and the second valve member 830 about the axis 833 such that the first valve member 828 allows exhaust to flow from the first exhaust output port 824 to the output assembly 802, while the second valve member 830 prevents the flow of exhaust from the second exhaust output port 826 to the output assembly 802. In the second mode of operation, heat from the exhaust is isolated from the tubes 848 and the fluid path 842, thus preventing the transfer of heat from the exhaust to the fluid.

The apparatus 800 may also include a sensor (not shown) to measure a temperature of the fluid in the fluid path 842. When the temperature increases to a certain pre-defined level, the actuation arm 832 may rotate the first valve member 828 and the second valve member 830 from the first position (FIG. 14A) to the second position (FIG. 14B), preventing any further transfer of heat from the exhaust to the fluid, and thus preventing any further increase in the temperature of the fluid. In one configuration, the pre-defined temperature may be approximately 212 degrees Fahrenheit.

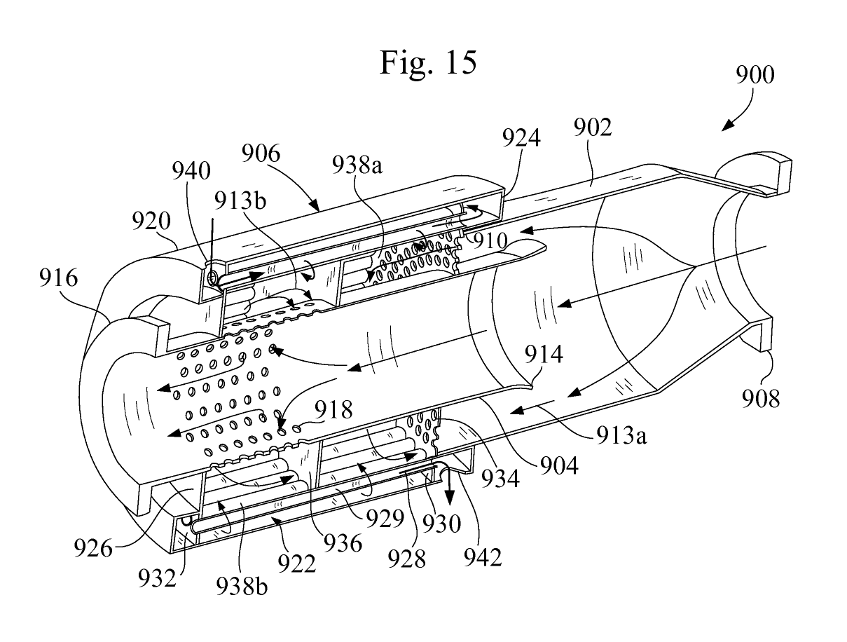

Turning to FIG. 15, another apparatus for quick warm-up of a motor vehicle constructed in accordance with the present teachings is illustrated and generally identified at reference character 900. The apparatus 900 may be similar to the apparatus 700, and similarly incorporated into systems 10, 100 for delivery of heat to the passenger cabin of a motor vehicle or delivery of heat to the engine upon start-up, as discussed above.

The apparatus 900 is generally shown to include a housing 902, a pipe 904, and a heat collector 906. The housing 902 may be a generally cylindrical member extending from a first end, defining a first exhaust input port 908, to a second end, defining a first exhaust output port 910. The first input port 908 may receive heated exhaust from the catalytic converter 16. The first output port 910 may deliver exhaust to the pipe 904 and to the heat collector 906.

The pipe 904 may be disposed concentrically within the housing 902, defining a chamber or exhaust flow path 913a between the housing 902 and the pipe 904. The pipe 904 may extend from a first end, defining a second exhaust input port 914, to a second end, defining a second exhaust output port 916. The second input port 914 may be in fluid communication with the first output port 912. The second output port 916 may deliver exhaust to a muffler 20 or a tailpipe (not shown). The pipe 904 may include a series of apertures 918 between the second input port 914 and the second output port 916. The apertures 918 may be arranged in various configurations. In one configuration the apertures 918 are arranged in a series of linear rows arranged circumferentially around the pipe 904.

The heat collector 906 may include a housing 920 and a heat absorbing arrangement 922. The housing 920 may be disposed concentrically to the housing 902 and the pipe 904. A first end 924 of the housing 920 may be mounted to the housing 902. A second end 926 of the housing 920 may be mounted to the pipe 904, thereby defining a chamber or exhaust flow path 913b between the pipe 904 and the heat collector 906.

The heat absorbing arrangement 922 may be disposed in the exhaust flow path 913b of the heat collector 906. The heat absorbing arrangement may include a plurality of tubes 929 extending between the first and second ends 924, 926 of the housing 920 and defining a fluid path 928. The tubes 929 may be similar to the tubes 644 (FIG. 12). The exhaust paths 913a, 913b may be isolated from the fluid path 928 by first and second annular walls 930, 932, respectively, extending radially between the housing 920 and the pipe 904. The first annular wall 930 may include a series of apertures 934 to allow fluid communication between the exhaust path 913a and the exhaust path 913b.

A third annular wall 936 may extend radially between the pipe 904 and the tubes 929. The third annular wall 936 may substantially divide the exhaust path 913b into a first portion 938a and a second portion 938b to improve the heat absorbing characteristics of the heat absorbing arrangement 922. The apertures 934 in the first annular wall 930 may allow for fluid communication between the exhaust path 913a and the first portion 938a of the exhaust path 913b. The apertures 918 in the pipe 904 may allow for fluid communication between the pipe 904 and the second portion 938b of the exhaust path 913b. As exhaust flows through the exhaust path 913b and around the tubes 929, heat may be transferred between the exhaust and the fluid in the fluid path 928.

The heat collector 906 is further illustrated to generally include an inlet 940 and an outlet 942. The inlet and outlet 940, 942 are in fluid communication with the fluid path 928 of the heat absorbing arrangement 922. The inlet 940 may also be in fluid communication with the heater core 40 for receiving a cooled fluid (i.e., coolant) from the heater core 40. The outlet 942 may also be in fluid communication with the expansion tank 42 and the pump 44 for routing coolant warmed by the heat collector 906 back to the heater core 40 or to the engine or transmission (not shown).

The heat collector 906 may similarly be incorporated into a combined housing with a muffler, catalytic converter, exhaust pipe, exhaust manifold, or any other component or pipe along a vehicle's exhaust path. Additionally, it will be understood that the present teachings, including the heat collector 906, may be employed for applications not including a catalytic converter.

While specific examples have been described in the specification and illustrated in the drawings, it will be understood by those skilled in the art that various changes may be made and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

What is claimed is:

1. A system for quick warm-up of a motor vehicle, the system comprising:
a housing, the housing having an input port, an output port, and defining a first exhaust flow path between the input port and the output port;
a heat collector in fluid communication with the housing and defining a second exhaust flow path, the heat collector having an inlet and an outlet and further defining a fluid path between the inlet and the outlet;
a valve mechanism disposed within the housing, the valve member operable to control the flow of exhaust between the first exhaust flow path and the second exhaust flow path.

2. The system for quick warm-up of a motor vehicle of claim 1, wherein the second exhaust flow path circumferentially surrounds the first exhaust flow path.

3. The system for quick warm-up of a motor vehicle of claim 1, wherein the second exhaust flow path is laterally offset relative to the first exhaust flow path.

4. The system for quick warm-up of a motor vehicle of claim 1, wherein the first exhaust flow path is defined by a pipe having a first end in fluid communication with the valve mechanism and a second end in fluid communication with the output port.

5. The system for quick warm-up of a motor vehicle of claim 4, wherein the heat collector and the pipe define a chamber therebetween, wherein the chamber is operable to fluidly communicate with the first exhaust flow path and the second exhaust flow path.

6. The system for quick warm-up of a motor vehicle of claim 4, wherein the pipe includes a plurality of apertures between the first and second ends thereof, the apertures operable to fluidly communicate with the first exhaust flow path and the second exhaust flow path.

7. The system for quick warm-up of a motor vehicle of claim 4, wherein a thermal insulator substantially surrounds the pipe between the first and second ends thereof.

8. The system for quick warm-up of a motor vehicle of claim 4, wherein the valve mechanism includes a valve member rotatably mounted to the housing and operable to allow fluid communication between the input port and the first end of the pipe in a first position, and operable to prevent fluid communication between the input port and the first end of the pipe in a second position.

9. The system for quick warm-up of a motor vehicle of claim 4, wherein the valve mechanism includes a first valve member and a second valve member, wherein in a first configuration the first valve member is operable to allow fluid communication between the input port and the first end of the pipe and the second valve member is operable to prevent fluid communication between the input port and the heat collector, and in a second configuration the first valve member is operable to prevent fluid communication between the input port and the first end of the pipe and the second valve member is operable to allow fluid communication between the input port and the heat collector.

10. The system for quick warm-up of a motor vehicle of claim 4, wherein the valve mechanism includes:
a valve housing having a first opening in fluid communication with the input port, a second opening in fluid communication with the first end of the pipe, a third opening in fluid communication with the heat collector, and a fourth opening in fluid communication with the heat collector, and
a valve member rotatably mounted to the valve housing and defining an aperture therethrough, wherein the aperture is in fluid communication with the first opening and the second opening in a first position.

11. The system for quick warm-up of a motor vehicle of claim 4, wherein the pipe is concentric to the heat collector.

12. The system for quick warm-up of a motor vehicle of claim 4, wherein the pipe is laterally offset from the heat collector.

13. The system for quick warm-up of a motor vehicle of claim 1, wherein the heat collector includes a plurality of tubes, each tube extending between a first end of the second exhaust flow path and a second end of the exhaust flow path.

14. The system for quick warm-up of a motor vehicle of claim 13, wherein each tube has a non-uniform cross section.

15. The system for quick warm-up of a motor vehicle of claim 13, wherein the plurality of tubes includes a first circular arrangement of tubes and a second circular arrangement of tubes, wherein the first and second circular arrangements circumferentially surround the first exhaust flow path.

16. The system for quick warm-up of a motor vehicle of claim 1, wherein the inlet of the heat collector is in fluid communication with a heater core.

17. The system for quick warm-up of a motor vehicle of claim 1, wherein the fluid path circumferentially surrounds the first exhaust flow path.

18. The system for quick warm-up of a motor vehicle of claim 1, wherein the fluid path is laterally offset from the first exhaust flow path.

19. A method for quick warm-up of a motor vehicle, the method comprising:
providing a housing defining a first exhaust flow path;
providing a heat collector defining a second exhaust flow path;
circulating exhaust through the second exhaust flow path;
circulating a coolant through the heat collector to extract heat from the exhaust; and
actuating a valve mechanism to stop the circulation of the exhaust through the second exhaust flow path and start the circulation of exhaust through the first exhaust flow path.

20. The method for quick warm-up of a motor vehicle of claim 19, wherein the stopping of the circulation of exhaust occurs upon sensing of a predetermined maximum temperature of the coolant.
